(19) United States
(12) Patent Application Publication
(10) Pub. No.: US 2013/0010206 A1
(43) Pub. Date: Jan. 10, 2013

(54) LIQUID CRYSTAL DISPLAY DEVICE AND TELEVISION RECEIVING APPARATUS

(75) Inventor: Seiji Kohashikawa, Osaka-shi (JP)

(73) Assignee: SHARP KABUSHIKI KAISHA, Osaka-shi, Osaka (JP)

(21) Appl. No.: 13/636,082

(22) PCT Filed: Mar. 29, 2011
(86) PCT No.: PCT/JP2011/057860

§ 371 Date: Sep. 19, 2012

(30) Foreign Application Priority Data
Mar. 31, 2010 (JP) 2010-080087
Mar. 28, 2011 (JP) 2011-069607

(51) Int. Cl. G09G 3/36; H04N 5/44; G09G 5/10

(52) U.S. Cl. 348/725; 345/690; 345/87; 348/E05.096

(57) ABSTRACT

Disclosed is a liquid crystal display device (1) provided with a liquid crystal panel (13) for displaying an input video signal, a backlight (10) applying light to the liquid crystal panel, a light source light emission control portion providing light emission of the backlight (10), and an area detection portion (11c) detecting a translating area (13T) translating in a video indicated by the input video signal. The translating area (13T) means, for example, a panning video, a scroll area, and a telop area. The light source light emission control portion is exemplified by a control CPU (15) and a light source drive portion (16). The control CPU (15) performs light emission control of light emitting areas (10a-10g) by controlling the light source driving portion (16), the light emission control including intermittent control. Regarding the light emitting area (10g) corresponding to the translating area (13T), the intermittent control is provided only to the light emitting area (10g), or provided to the light emitting area (10g) such that a turn-off period becomes longer as compared to the other light emitting areas (10a-10f). The present invention can prevent a failure of video from being emphasized by intermittent control of a light source in a display area likely to have a failure of video.

### TECHNICAL FIELD

The present invention relates to a liquid crystal display device and a television receiving apparatus and more particularly to a liquid crystal display device driving a light source area divided into a plurality of parts to emit light in synchronization with writing of a video signal to a liquid crystal panel, and a television receiving apparatus including the liquid crystal display device.

### BACKGROUND ART

As compared to cathode-ray tubes (CRTs) conventionally dominantly used for the purpose of realizing moving images, LCDs (Liquid Crystal Displays) have a drawback, so-called motion blur, which is the blurring of a contour of a moving portion perceived by a viewer when displaying an image with a motion. It is known that this motion blur arises from the display system of LCDs itself.

Since fluorescent material is scanned by an electron beam to cause emission of light for display in CRTs, the light emission of pixels is basically impulse-like although slight the afterglow of the fluorescent material somewhat exists. On the other hand, in the case of LCDs, an electric charge is accumulated by applying an electric field to liquid crystal and is retained at a relatively high rate until the next time the electric field is applied. Especially, in the case of the TFT (Thin Film Transistor) system, since a TFT switch is disposed for each dot making up a pixel and each pixel is normally disposed with an auxiliary capacity, the ability to retain the accumulated charge is extremely high. Therefore, the light emission continues until the pixels are rewritten by the application of the electric field based on the image signal of the next frame (or field). This is called a hold-type display system.

Since the impulse response of the image displaying light has a temporal spread in the hold-type display system as described above, temporal frequency characteristics deteriorate along with spatial frequency characteristics, resulting in the motion blur. Since the human eyes can smoothly follow a moving object, if the light emission time is longer as in the hold type, the movement of image seems jerky and unnatural due to the time integration effect. To reduce the motion blur due to sight-line follow-up, a technique is known that performs pseudo impulse drive by blinking a backlight light source in a liquid crystal panel.

FIG. 9 is a diagram for explaining the motion blur in a hold-type display system. The motion blur due to sight-line follow-up can be reduced by the impulse drive because of the following reason. For example, if a moving object moves to the right in a background area as depicted in FIG. 9(A), a sight line of an observer follows the object o and moves to the right. In this case, a motion blur width can be obtained by performing temporal integration in the sight-line follow-up direction for one horizontal line of a portion displaying the object o.

FIG. 9(B) is a diagram of a moving state of the object o when a vertical axis is defined as a time axis and a horizontal axis is defined as a pixel position on a display screen. In this case, a period for performing the hold drive of a liquid crystal display device is set to 1/120 second. This period indicates a frame period when one frame is displayed in 1/120 second by the frame interpolation of a 60 Hz image. Dot lines of FIG. 9(B) indicate sight line tracking (eye-tracking) to the movement of the object o.

In this case, the liquid crystal display device performing the hold drive retains luminance for a period of 1/120 second. Therefore, an area t1 having the same luminance integrated value as the original image (the area thereof is indicated by T1) is narrower than the area T1 of the shape of the original image and areas t2 and t3 are generated that have intermediate values as luminance integrated values. The area t3 has a luminance integrated value closer to the luminance of the background area as compared to the area t2. The widths of the areas t2 and t3 make up a motion blur width.

FIG. 10 is a diagram for explaining the motion blur due to pseudo impulse drive. FIG. 10(A) depicts a state of the moving object o moving from left to right in a background area as is the case with FIG. 9(A). As depicted in FIG. 10(B), in this example, liquid crystal is driven in accordance with the pseudo impulse drive. In this case, since the luminance of one frame period ( 1/120 second) is once turned to zero (turned off) within one frame period, an area t4 having an intermediate value as the luminance integrated value becomes narrower, leading to a narrower motion blur width. As described above, the pseudo impulse drive can temporarily concentrate the luminance to reduce the motion blur.

In this case, if the backlight is simply entirely blinked, a transition state of liquid crystal is emphasized and visually recognized as a ghost of a moving object in an image. Particularly in such a case as moving a line segment, a trailing phenomenon is visually recognized and the line segment is doubly or triply seen, causing significant deterioration of display quality. To take measures against such a ghost, a backlight scan system is used that has a backlight divided into a plurality of parts to blink light sources of each divided area in synchronization with writing of a video signal.

As described above, in the backlight scan technique, an image frame period is provided with a backlight turn-off period to reduce a period of displaying the same video such that the pseudo impulse drive is realized, thereby improving the moving image performance. For example, Patent Document 1 discloses a technique of intermittently lighting a backlight light source within one frame period (one vertical period) in a pseudo manner closer to the impulse drive so as to prevent motion blur generated when a moving image is displayed.

### PRIOR ART DOCUMENT

### Patent Document

Patent Document 1: Japanese Patent Publication No. 3994997

### SUMMARY OF THE INVENTION

### Problem to be Solved by the Invention

However, if an object video has a failure such as a blur, such a backlight scan technique emphasizes the failure and deteriorates the moving image performance.

For example, if interpolation is performed between frames for double-speed drive display etc., an interpolation image frame must be calculated as an interpolation frame from two previous and subsequent original image frames, for example, and the interpolation frame may cause a failure such as a blur in some videos. If such a failed video is processed in a backlight scan system, the failure is emphasized and the moving image performance is deteriorated. Since a failure may also obviously be caused depending on a type of a video process if the inter-frame interpolation is not performed, this problem is not limited to the case of performing the inter-frame interpolation.

The present invention was conceived in view of the situations and it is therefore an object of the present invention to prevent a failure of video from being emphasized by intermittent control of intermittently repeating turning on and off of a light source in a display area likely to have a failure of video in a liquid crystal display device driving light emitting areas acquired by dividing the light source into a plurality of parts to emit light in synchronization with writing of a video signal to a liquid crystal panel, and a television receiving apparatus including the liquid crystal display device.

### Means for Solving the Problem

To solve the above problems, a first technical means of the present invention is a liquid crystal display device comprising: a liquid crystal panel displaying an input video signal; a light source applying light to the liquid crystal panel, and a light source light emission control portion providing light emission control to each light emitting area acquired by dividing the light source into a plurality of areas, further comprising: an area detecting portion detecting a translating area translating in a video indicated by the input video signal, wherein the light source light emission control portion provides light emission control of the light emitting areas in synchronization with writing of a video signal to the liquid crystal panel, wherein the light emission control of the light emitting areas includes intermittent control in which the light source is intermittently repeatedly turned on and off, and wherein for a light emitting area corresponding to the translating area detected by the area detecting portion, the intermittent control is provided only to the light emitting area or provided to the light emitting area such that a turn-off period becomes longer as compared to the other light emitting areas.

A second technical means is the liquid crystal display device of the first technical means, wherein the light source light emission control portion provides control of changing a current during a turn-on period and/or PWM control to a light emitting area to be provided with the intermittent control such that an average light emission luminance value of the light emitting area during the intermittent control is maintained at the same value as when the intermittent control is not provided.

A third technical means is the liquid crystal display device of the first or the second technical means, further comprising a frame interpolating portion performing interpolation between frames of the input video signal to multiply a frame frequency before the interpolation by n (n is a natural number equal to or greater than two).

A fourth technical means is the liquid crystal display device of any one of the first to the third technical means, wherein the area detecting portion includes a motion vector detecting portion detecting a motion vector of the input video signal.

A fifth technical means is the liquid crystal display device of any one of the first to the fourth technical means, wherein the light emitting area corresponding to the translating area is a light emitting area entirely occupied by the translating area.

A sixth technical means is the liquid crystal display device of any one of the first to the fourth technical means, wherein the light emitting area corresponding to the translating area is a light emitting area having a predetermined rate of an area occupied by the translating area.

A seventh technical means is the liquid crystal display device of any one of the first to the fourth technical means, wherein the light emitting area corresponding to the translating area is a light emitting area including at least a portion of the translating area.

An eighth technical means is a television receiving apparatus comprising the liquid crystal display device of any one of the first to the seventh technical means.

### Effect of the Invention

The present invention can prevent a failure of video from being emphasized by intermittent control of intermittently repeating turning on and off of a light source in a display area likely to have a failure of video in a liquid crystal display device driving light emitting areas acquired by dividing the light source into a plurality of parts to emit light in synchronization with writing of a video signal to a liquid crystal panel, and a television receiving apparatus including the liquid crystal display device.

### BRIEF DESCRIPTION OF DRAWINGS

FIG. 1 is a diagram of an exemplary configuration of a backlight applicable to a liquid crystal display device of the present invention.

FIG. 2 is a block diagram of a general configuration of the liquid crystal display device according to the present invention.

FIG. 3 is a diagram of an exemplary configuration of a frame frequency converting portion in the liquid crystal display device of FIG. 2.

FIG. 4 is a diagram of an example of an outside appearance and a backlight arrangement example of the liquid crystal display device of FIG. 2.

FIG. 5 is a diagram of a light source control example when backlight scan control is not provided by a light source driving portion in the liquid crystal display device of FIG. 2.

FIG. 6 is a diagram of an example of the backlight scan control provided by the light source driving portion in the liquid crystal display device of FIG. 2.

FIG. 7 is a diagram of another example of the backlight scan control provided by the light source driving portion in the liquid crystal display device of FIG. 2.

FIG. 8 is a diagram of an example of an outside appearance and another backlight arrangement example of the liquid crystal display device of FIG. 2.

FIG. 9 is a diagram for explaining a motion blur in a hold-type display system.

FIG. 10 is a diagram for explaining a motion blur due to pseudo impulse drive.

### MODES FOR CARRYING OUT THE INVENTION

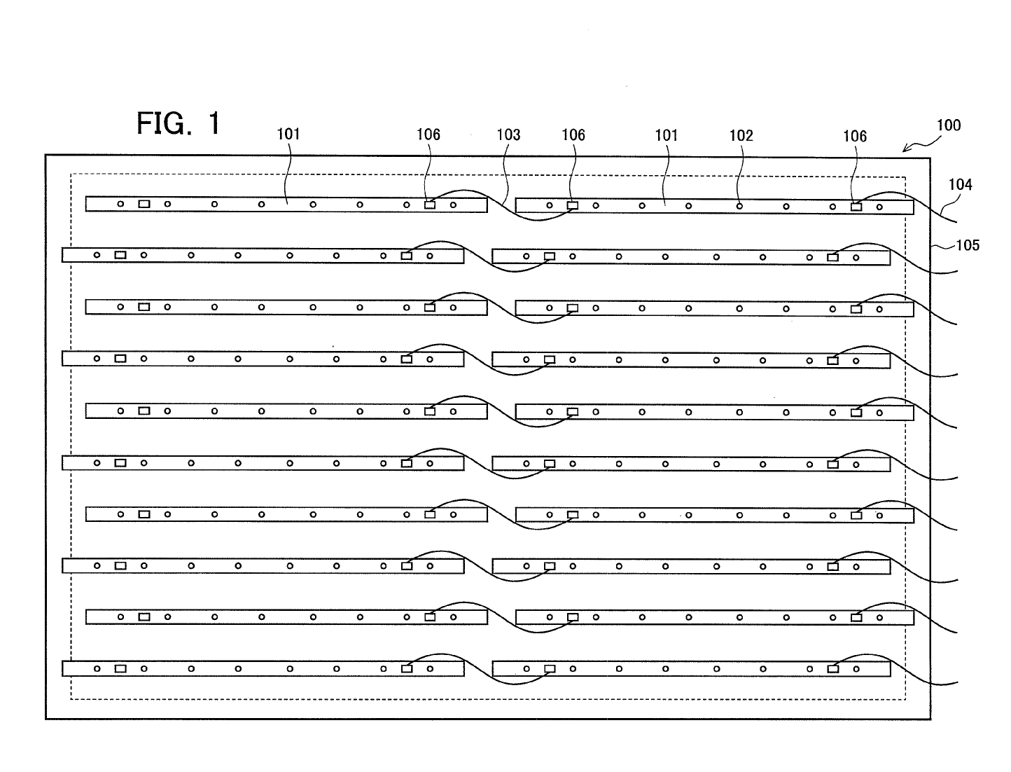

FIG. 1 is a diagram of an exemplary configuration of a backlight applicable to a liquid crystal display device of the present invention. The backlight of this example is configured as an array-type LED backlight.

A backlight 100 has a plurality of LED substrates 101 arranged on a chassis 105. The LED substrates 101 have a laterally-elongated rectangular strip shape and are arranged such that the longitudinal direction of the rectangle matches the horizontal direction of a screen of the liquid crystal display device.

The example of FIG. 1 is exemplarily illustrated as the array-type LED backlight 100 applied to a liquid crystal display device with a 40 inch screen. In this example, the LED substrates 101 are horizontally divided into two parts, and ten rows each including the two LED substrates 101 are vertically arranged. A reason of the horizontal division into two parts is that the LED substrates 101 generally have maximum vertical and horizontal outside dimensions at the time of manufacturing, i.e., standard lengths. Although the standard lengths vary depending on a material and a manufacturing apparatus of the LED substrates 101, the standard lengths are 510 mm in height and 340 mm in width, for example. Therefore, if either vertical or horizontal dimension of the LED substrate 101 exceeds the standard length, the LED substrate 101 is divided into several parts for manufacturing.

In the present invention, such horizontal division of the LED substrates 101 is not essential and this example merely represents an exemplary configuration applicable to the present invention.

Each of the LED substrates 101 has a plurality of (in this example, eight) LEDs 102 linearly arranged. Therefore, in the array-type LED backlight 100 of FIG. 1, a total of 160 LEDs 102 are used in the entire screen. The LED chips 102 are generally arranged in a hexagonal lattice shape. In the hexagonal lattice shape arrangement, a virtual regular hexagon is formed around one of the LED chips 102, and the other LED chips 102 are arranged at the apexes thereof. The LED chips 102 may simply be arranged in a lattice pattern instead of this lattice arrangement and, the backlight 100 can apply uniform backlight to a liquid crystal panel in any arrangement.

The LEDs 102 mounted on each of the LED substrates 101 are connected to each other in series by a wiring pattern (not depicted) formed on each of the LED substrates 101. A harness 103 is disposed to connect two horizontally divided LED substrates 101, and a harness 104 is disposed to connect one of the LED substrates 101 to an external driver substrate. Each of the LED substrates 101 is disposed with connectors 106 for connecting the harnesses 103 and 104. Each of the LED substrates 101 is fixed to the chassis 105 by screws not depicted located beside the connectors 106.

The backlight 100 includes an LED driver loaded on the driver substrate (drive circuit substrate) not depicted. The LED driver supplies a current to the LEDs 102 connected in series to drive the LEDs 102 through current or PWM (pulse width modulation) control or both of these controls. Therefore, the vertically arranged rows of units each made up of the two LED substrates 101 can respectively be driven independently of each other.

The number of LEDs normally varies depending on a screen size. Although the number of the units each made up of the two LED substrates 101 is ten in the liquid crystal display device with a 40 inch screen of the example described above, for example, the number of the units is nine in the case of a 32 inch screen; the number of the units is twelve in the case of a 46 inch screen; and the number of the units of the LED substrates 101 (i.e., the number of LEDs) varies as needed depending on a screen size, necessary brightness, etc. These numbers of LEDs and the numbers of LEDs per substrate are described as examples, and the number of LEDs and the number of units are not limited in the present invention.

The liquid crystal display device according to the present invention is not only applicable to a backlight such as the array-type LED backlight described above but also to a matrix-type LED backlight made up of LEDs arranged all over a substrate having substantially the same size as a screen size and a backlight made up of a plurality of cold cathode fluorescent lamps (CCFLs) arranged in parallel. Those backlights are available as long as a backlight scan function described later is equipped. However, in the following example, description will be made on the basis that the array-type LED backlight is used.

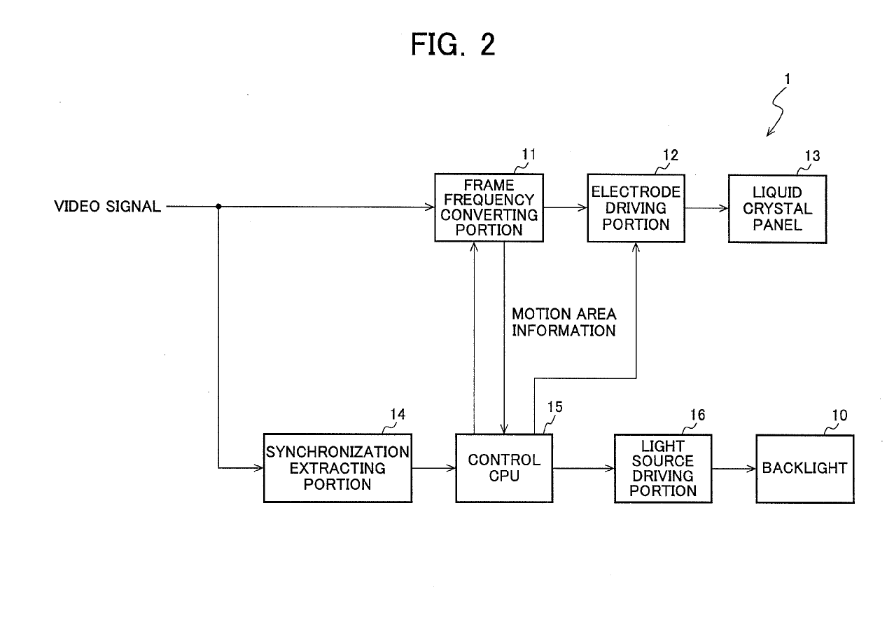

FIG. 2 is a block diagram of a general configuration of the liquid crystal display device according to the present invention. A liquid crystal display device 1 includes a frame frequency converting portion 11, an electrode driving portion 12, a liquid crystal panel 13, a synchronization extracting portion 14, a control CPU 15, a light source driving portion 16, and a backlight 10. For example, a backlight exemplarily illustrated as the backlight 100 of FIG. 1 is applicable to the backlight 10.

The synchronization extracting portion 14 extracts vertical/horizontal synchronization signals from an input video signal (e.g., 60 Hz progressive scan signal). The control CPU 15 controls an operation of each portion based on the vertical/horizontal synchronization signals etc., extracted by the synchronization extracting portion 14.

The frame frequency converting portion 11 converts the frame frequency of the input video signal into an n-fold frequency (n is a natural number equal to or greater than two) based on a control signal from the control CPU 15. For example, the frame frequency converting portion 11 performs frequency conversion such that a one-frame image of 2 input video signals has a double frame frequency (120 Hz) based on the control signal from the control CPU 15. As a result, the frame frequency converting portion 11 continuously outputs to the electrode driving portion 12 a video signal (image signal) having a frame display period (vertical display period) of 1/120 second (about 8.3 msec) for the liquid crystal panel 13. The electrode driving portion 12 performs the write scanning of the video signal in one frame period of the input video signal.

The present invention can be configured as a television receiving apparatus including the liquid crystal display device described with reference to FIG. 2 and described in detail later. This television receiving apparatus includes a means of selecting, demodulating, and decoding a broadcast signal received by an antenna to generate a reproduction video signal, and inputs this reproduction video signal as the input video signal into the frame frequency converting portion 11 and the synchronization extracting portion 14. As a result, the received broadcast signal can eventually be displayed on the liquid crystal panel 13.

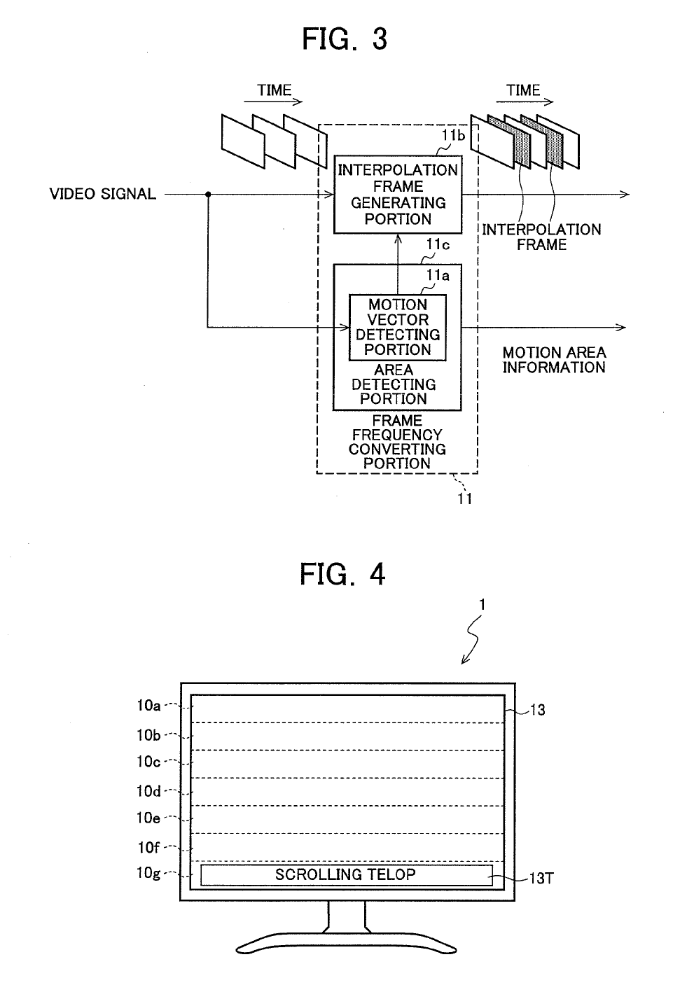

FIG. 3 is an example of a configuration of the frame frequency converting portion in the liquid crystal display device of FIG. 2. The frame frequency converting portion 11 performs frame interpolation using an FRC (frame rate converter) technique to convert a frame frequency and improves color and gradation expression through the frame interpolation. The frame frequency converting portion 11 includes a motion vector detecting portion 11a detecting motion vector information from an input video signal, and an interpolation frame generating portion 11b generating an interpolation frame based on the motion vector information acquired by the motion vector detecting portion 11a.

In a motion compensation frame interpolation process, it is indispensable for detecting a motion vector for motion compensation. Representative techniques for the motion vector detection include a block matching method and a gradient method, for example. The motion vector detecting portion 11a uses these techniques to detect a motion vector for each pixel or each small block between two consecutive frames. The interpolation frame generating portion 11b uses the detected motion vector to interpolate each pixel or each small block of an interpolation frame between two frames. Therefore, an image at an arbitrary position between two frames is correctly positionally-compensated and interpolated to convert the frame number. The interpolation frame generating portion 11b sequentially outputs an interpolation frame signal along with an input frame signal to execute a process of converting a frame rate of an input video signal from 60 frames per second (60 Hz) to 120 frames per second (120 Hz), for example.

If motion vector information is included in an input video signal in some form, the interpolation frame generating portion 11b may use this information. For example, image data compressed and coded by using an MPEG mode includes motion vector information of a moving image calculated at the time of coding and the interpolation frame generating portion 11b may be configured to acquire this motion vector information.

As exemplarily illustrated by the frame frequency converting portion 11, a frame interpolating portion is preferably included that performs interpolation between frames (not limited to internal interpolation) for an input video signal to multiply a frame frequency before the interpolation by n (n is a natural number equal to or greater than two). This is because the light emission control of the present invention described later becomes beneficial when a frame frequency is increased since the possibility of failure of video becomes higher.

Describing the light emission control, first, the control CPU 15 outputs to the light source driving portion 16 a control signal controlling the turning on/off of the backlight 10 based on the vertical synchronization signal extracted by the synchronization extracting portion 14. The backlight 10 is a light source applying light to the liquid crystal panel 13 displaying an input video signal. The light source driving portion 16 controls the lighting of the backlight 10 in accordance with the control signal output from the control CPU 15.

The liquid crystal display device 1 includes a light source light emission control portion that provides light emission control to each light emitting area in synchronization with writing of a video signal to the liquid crystal panel 13. The light emitting areas are areas acquired by dividing the light source exemplarily illustrated as the backlight 10 into a plurality of parts. The light emission control provided by the light source light emission control portion includes intermittent control of intermittently repeating the turning on and off of the backlight 10. The light source light emission control portion is exemplarily illustrated by the control CPU 15 and the light source driving portion 16. The control CPU 15 controls the light source driving portion 16 to provide the light emission control including the intermittent control to the backlight 10. In the following description, this intermittent control is often referred to as backlight scan control.

The liquid crystal display device 1 according to the present invention extracts an area having no or little possibility of a failure of video. Therefore, the liquid crystal display device 1 includes an area detecting portion detecting a translating area (a parallel movement region) translating in a video indicated by an input video signal. The translating area means an area with a translating object etc., and more specifically means a panning/scrolling area and a telop area of a video. These areas basically have a motion vector of a certain width in a certain direction (that may be any direction) and, therefore, are likely to be coded/decoded without a video failure.

The area detecting portion may be disposed as an area detecting portion 11c in the frame frequency converting portion 11 as depicted in FIG. 3. The area detecting portion is not limited to this example and may be disposed in the liquid crystal display device in any way. The area detecting portion preferably includes a motion vector detecting portion detecting a motion vector of an input videos signal as exemplarily illustrated by the motion vector detecting portion 11a. However, the frame interpolating portion such as the frame frequency converting portion 11 is not indispensable for the present invention and, needless to say, the motion vector detecting portion may be disposed even in such a case.

In this example, the area detecting portion 11c detects the translating area based on the motion vector detected by the motion vector detecting portion 11a and outputs the translating area as motion area information to the control CPU 15. The motion vector information at the time of coding may be acquired in the same way as the time of generation of an interpolation frame and the translating area may be detected from the motion vector information. The control CPU 15 transfers this motion area information to the light source driving portion 16 or transfers drive control information to which this motion area information is added, to the light source driving portion 16. In the following description, the details of the drive control are determined by the control CPU 15 as in the latter case.

FIG. 4 is a diagram of an example of an outside appearance and a backlight arrangement example of the liquid crystal display device of FIG. 2.

For a light emitting area 10g corresponding to a detected translating area 13T, the intermittent control in the light source light emission control portion is provided only to the light emitting area 10g or provided to the light emitting area 10g such that a turn-off period becomes longer than the other light emitting areas 10a to 10f. When the other light emitting areas 10a to 10f have a turn-off period and the turn-off period of the light emitting area 10g is set longer, a normal motion blur can be reduced in the other light emitting areas 10a to 10f, and a blur can be reduced by setting the turn-off period longer in a portion of a telop etc., where the blur is strongly recognized.

This control may be provided by the control CPU 15 to the light source driving portion 16 in response to the motion area information indicative of the translating area. As a matter of course, if two or more translating areas exist, such control may naturally be provided to all the translating areas. In the present invention, a translating area may be obtained and the backlight scan control may be provided only to, or strongly provided to, the object area.

As described above, the liquid crystal display device 1 according to the present invention strongly provides the intermittent control to a light emitting area corresponding to the translating area, which is an area with a high possibility of non video failure, as compared at least to the other light emitting areas and, therefore, a video failure can be prevented from being emphasized by the intermittent control in the display area other than the area with a high possibility of non video failure. In other words, a failure of video can be prevented from being emphasized by the intermittent control of intermittently repeating the turning on and off of the light source in the display area with a high possibility of including a video failure. More generally, the present invention can analyze a motion in a video and perform the backlight scan only in a necessary portion to improve the moving image performance. In contrast, conventional backlight scan control gives no consideration to video quality and, therefore, if a video originally has a failure, the failure may be emphasized and the moving image performance may be deteriorated.

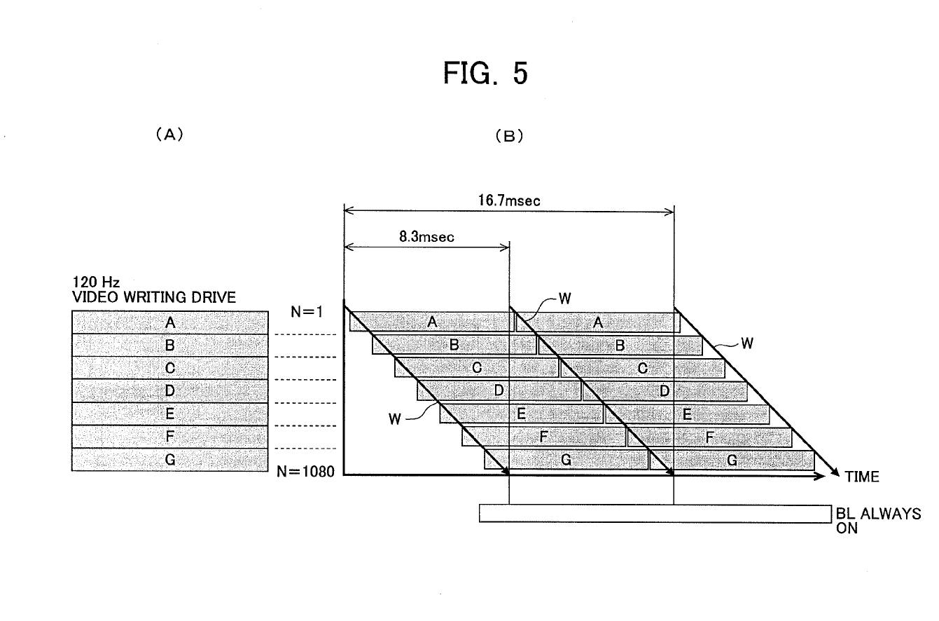

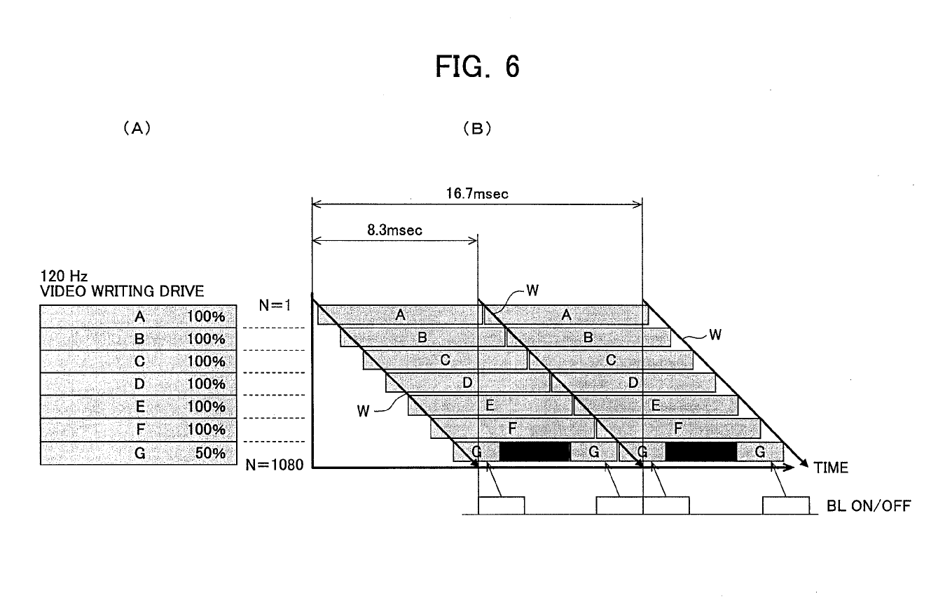

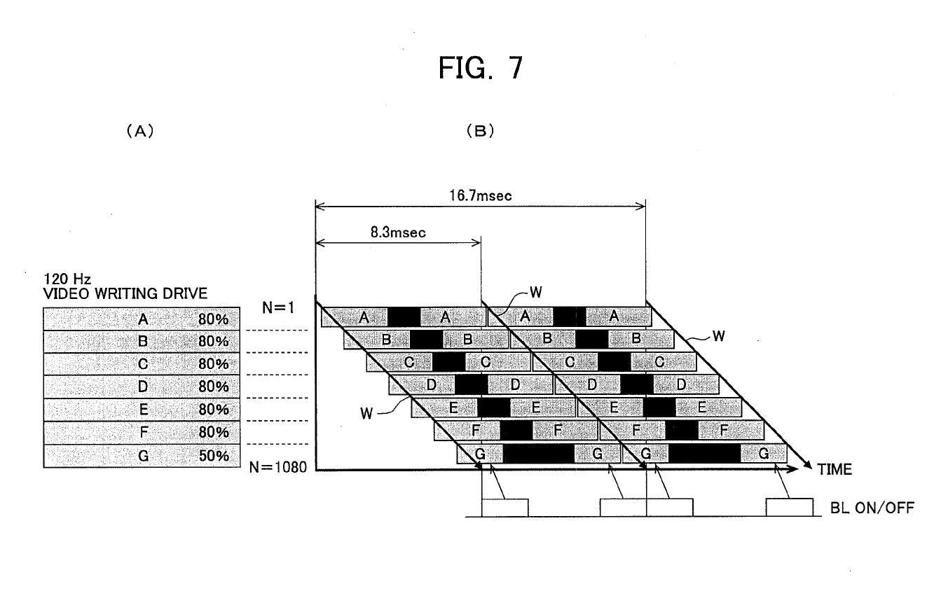

The backlight scan control of the present invention will be described with reference to FIGS. 5 to 7. FIG. 5 is a diagram of a light source control example when the backlight scan control is not provided by the light source driving portion in the liquid crystal display device of FIG. 2, and FIGS. 6 and 7 are diagrams of examples when the backlight scan control is provided in the liquid crystal display device of FIG. 2. FIGS. 6 and 7 depict examples of controls different from each other.

In these examples, the writing drive of a video as depicted in FIG. 5(A) is performed to a liquid crystal panel at 120 Hz. The number of pixels of the liquid crystal panel in this case is 1080 in height by 1920 in width, for example. In these examples, a one-frame still image consisting of 192×1080×RGB×8-bit information is updated at the speed of 120 frames per second to display a moving image on the liquid crystal panel 13. Therefore, a still image is written to the liquid crystal panel 13 every ½ time of 60 Hz drive (about 8.3 msec). In FIG. 5, W denotes the write timing of a video signal in the liquid crystal panel.

As depicted in FIG. 5(B), a video signal is written to the liquid crystal panel by vertical scanning from the top stage. Therefore, a video is sequentially updated from a first line (N=1) of the liquid crystal panel with a write start time gradually delayed until the last 1080th line (N=1080) is updated. A video updated in each line is held for 1/120 second (about 8.3 msec).

In the backlight 10, LED units A to G (respectively corresponding to the light emitting areas 10a to 10g of FIG. 4) each consisting of two LED substrates can individually be controlled. Although the liquid crystal panel having 1080 lines is made up of 7 vertically arranged rows of LED units in this example for simplicity, the LED arrangement configuration is not particularly limited as described above as long as each of the light emitting areas can be controlled. When the backlight scan control is not provided, LEDs are always turned on in the backlight 10. Therefore, the temporal frequency characteristics deteriorate as described above particularly in a moving image with a motion, leading to the deterioration of the spatial frequency characteristics, and the motion blur becomes more visible due to the time integration effect.

Although the example of FIG. 6 is an example of writing a video as depicted in FIG. 6(A) to the liquid crystal panel at 120 Hz as is the case with the example of FIG. 5, the translating area 13T is detected as in FIG. 4 in this example. If the backlight scan is performed, the LED units A to F corresponding to the light emitting areas 10a to 10f of FIG. 4 are controlled in the same way as FIG. 5, i.e., are always turned on, as depicted in FIG. 6(B). On the other hand, for the LED unit G corresponding to the light emitting area 10g of FIG. 4, the ON (turning on)/ OFF (turning off) control of the backlight is provided in accordance with writing of a video signal. The LED unit G is controlled to be turned on/off at a predetermined timing based on the writing of the video signal. As a result, pseudo impulse drive is performed to reduce the motion blur.

When T denotes a frame period ( 1/120 second=about 8.3 msec) of an image updated from the top stage to the bottom stage of a screen and τ denotes a turn-on period of the backlight in this frame period T, an ON duty (lighting duty) D can be expressed by D=τ/T.

In this example, the ON duty of the backlight is set to 50% and the frame period T is controlled at 1/120 second (120 Hz).

At least if the ON duty of the backlight is not 100%, the backlight is preferably turned off during a period including a temporal midpoint in one frame period T. As a result, during a period of transition of a liquid crystal state toward a target gradation within one frame period, a period enabling visual recognition of a video due to the lighting of the backlight can be divided into periods before and after the turn-off period. More preferably, this turn-off period has the same periods (time lengths) before and after the midpoint of one frame period. Therefore, preferably, the temporal midpoint of the turn-off period matches the midpoint of the one frame period T.

In this example, the ON duty is 50%, a turn-off period per frame period T is 0.5/120 seconds. The turn-off period is set such that the backlight is turned off for the same time periods before and after the temporal midpoint of the one frame period T. Therefore, the backlight is tuned on for 0.25/120 seconds from the start of the one frame period T and then turned off for 0.5/120 seconds. The backlight is then tuned on again and maintained for 0.25/120 seconds.

As a result, the backlight turn-on period of the LED unit G per frame period is set to 50%. The write timing of a video signal can be defined as the write timing of a first line of an object divided area (an area corresponding to the LED unit G and the light emitting area 10g) when the number of horizontal lines (1080 in this example) of the liquid crystal panel is divided into seven parts. Such backlight scan control can suppress the deterioration of the temporal frequency characteristics to reduce the motion blur.

The example of FIG. 7 is an example of writing a video as depicted in FIG. 7(A) to the liquid crystal panel at 120 Hz and the translating area 13T is detected as in FIG. 4, as is the case with the example of FIG. 6. However, in the example of FIG. 7, instead of providing the intermittent control only to the light emitting area 10g in accordance with the detection of the translating area 13T as in the example of FIG. 6, the intermittent control is provided to the light emitting area 10g such that the turn-off period becomes longer than the other light emitting areas 10a to 10f. In other words, if the backlight scan is performed in association with the detection of the translating area 13T, the LED units A to F are intermittently turned on as depicted in FIG. 7(B) rather than always turning on the LED units A to F as depicted in FIG. 6(B).

In this example, the LED units A to Fare intermittently turned on with the ON duty of 80% while the LED unit G is turned on with the ON duty of 50% as described above so as to achieve a longer turn-on period. Describing the LED units A to F, a turn-off period per frame period T is 0.2/120 seconds. The turn-off period is set such that the backlight is turned off for the same time periods before and after the temporal midpoint of the one frame period T. Therefore, the backlight is tuned on for 0.4/120 seconds from the start of the one frame period T and then turned off for 0.2/120 seconds. The backlight is then tuned on again and maintained for 0.4/120 seconds. By turning on/off not only the LED unit G but also the LED units A to F at the predetermined timing based on writing of a video signal, the pseudo impulse drive can be performed to reduce the motion blur.

Although an insertion rate of black is changed in the screen due to the backlight scan control described with reference to FIGS. 5 to 7 etc., preferably, luminance is prevented from changing to suppress variations of luminance in each area by varying a current during a turn-on period or providing PWM control in the LED unit G. The backlight may naturally be driven such that the variations are suppressed by both the variable current and the PWM control.

Specifically, the light source light emission control portion provides the control of changing a current during a turn-on period and/or the PWM control to a light emitting area corresponding to the translating area such that an average light emission luminance value of the light emitting area during the provision of the intermittent control is maintained at the same (constant) value as when the intermittent control is not provided. The change in current is basically an increase. Maintaining the same value as when the intermittent control is not provided means that the current during a turn-on period is increased or the ON duty of the PWN control is increased so as to compensate the average light emission luminance value forced to decrease due to the turn-off period. The frequency of the PWM control in this case is fairly higher than the frequency of the intermittent control described above. Even in another light emitting area, if the intermittent control is provided, the control of changing a current during a turn-on period and/or the PWM control are naturally provided such that the same average light emission luminance value is acquired when the intermittent control is provided and when intermittent control is not provided. Describing an example of changing a current during a turn-on period by reference to the example of FIG. 6, if a drive current value of the LED unit F is 10 mA, a current value of the LED unit G during turn-on is on the order of 200 mA provided that the turn-on period accounts for 50% and that the luminance of LED and the drive current are in substantially proportional relation.

As described above, the light source light emission control portion preferably provides the control of changing a current during a turn-on period and/or the PWM control to a light emitting area to be subjected to the intermittent control such that the average light emission luminance value of the light emitting area during the intermittent control is maintained at the same value as when the intermittent control is not provided. Although a luminance difference is generated in each area unless an insertion rate of black is kept constant in each area, the variations of luminance in each area can be suppressed by providing such control.

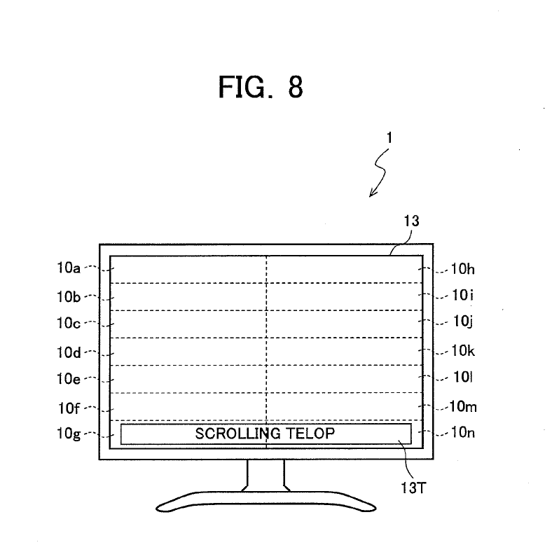

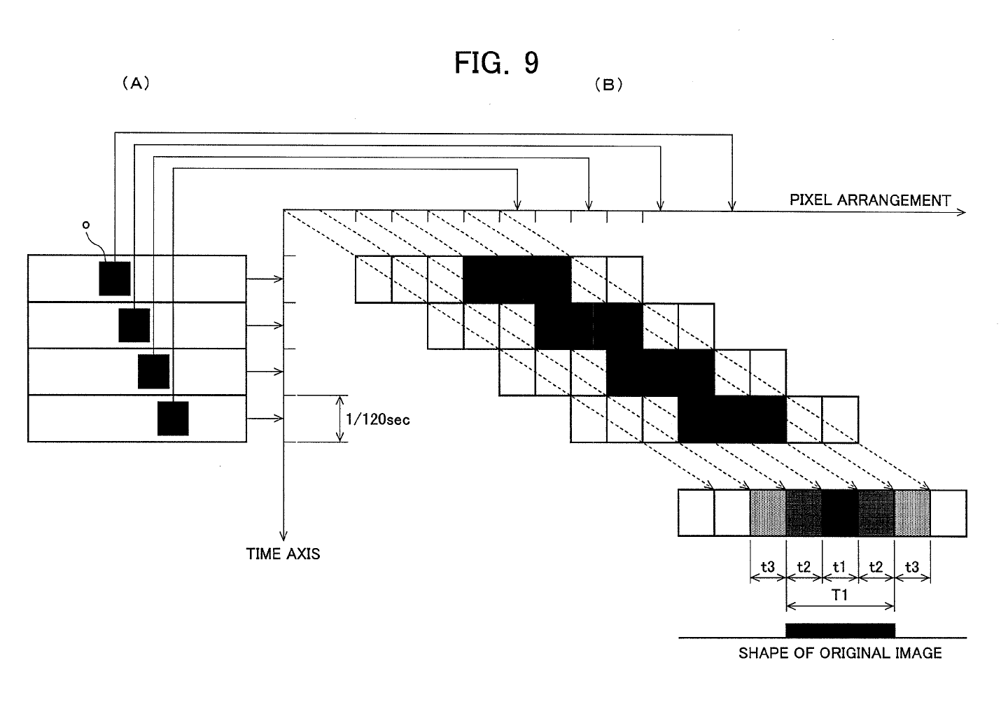

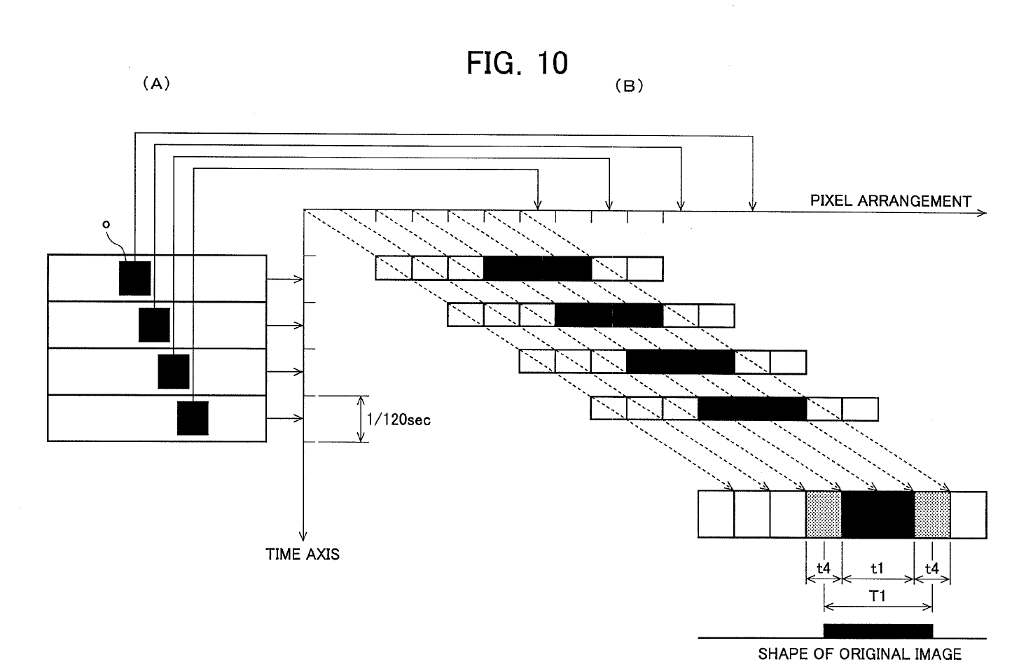

FIG. 8 is a diagram of an example of an outside appearance and another backlight arrangement example of the liquid crystal display device of FIG. 2. The light emitting areas may be divided in any manner such as employing light emitting areas 10a to 10n exemplarily illustrated in FIG. 8 instead of the light emitting areas 10a to 10g exemplarily illustrated in FIG. 4, for example. The light emitting areas 10a to 10n of FIG. 8 are acquired by dividing a display area vertically into seven blocks and horizontally into two blocks. In the example of FIG. 8, the light emitting areas corresponding to the translating area 13T are the light emitting areas 10g and 10n.

A relationship between the translating area and the light emitting areas may be determined in the liquid crystal display device 1 in advance and stored to be readable with the control CPU 15. The boundary etc., of the light emitting areas may be defined in advance. For example, a light emitting area corresponding to the translating area may be defined as a light emitting area entirely occupied by the translating area (a light emitting area having the entire area occupied by the translating area). When a certain light emitting area is observed, if the light emitting area is completely filled up with the translating area, the light emitting area may be determined as corresponding to the translating area. By using such a determining method, in the case of a scrolling telop, the intermittent control etc., are provided if the entire detection area falls within the area of the telop, i.e., if the scrolling telop is displayed entirely from the right end to the left end of the screen as in the example of FIG. 4. This enables improvement in the area where the greatest effect is produced. As a result, the intermittent control is provided only in a light emitting area entirely occupied by the translating area or the intermittent control is provided such that the turn-off period becomes longer as compared to the other light emitting areas.

A light emitting area corresponding to the translating area may be defined as a light emitting area having a predetermined rate of an area occupied by the translating area. As a result, the intermittent control is provided only in a light emitting area having a predetermined rate of an area occupied by the translating area or the intermittent control is provided such that the turn-off period becomes longer as compared to the other light emitting areas. By using such a determining method, in the case of a scrolling telop, the intermittent control etc., are provided if a portion of the detection area falls within the telop area, i.e., even when the telop is starting or when the telop is ending. This enables prompt response to the telop display. As a result, the intermittent control is provided only in a light emitting area including a portion of the translating area or the intermittent control is provided such that the turn-off period becomes longer as compared to the other light emitting areas.

A light emitting area corresponding to the translating area may be defined as a light emitting area including at least a portion of the translating area. As a result, the intermittent control is provided only in a light emitting area including at least a portion of the translating area or the intermittent control is provided such that the turn-off period becomes longer as compared to the other light emitting areas. By using such a determining method, in the case of a scrolling telop, the intermittent control etc., are provided if a size of the telop is large and a portion of the telop enters the next detection area. This enables the entire telop to be supported regardless of a size of the telop. As a result, the intermittent control is provided only in a light emitting area including a portion of the translating area or the intermittent control is provided such that the turn-off period becomes longer as compared to the other light emitting areas.

Although the translating area has been described as an area detected by detecting motion vectors from an input video signal in accordance with a degree of alignment etc., of the motion vectors in the examples, an area superimposed as OSD (On Screen Display) data may also be included. In this case, a case of a translating OSD image from OSD data or underlying data may be detected from motion vectors in the same way or, if a command for translation is prescribed, the commands may be searched.

### EXPLANATIONS OF LETTERS OR NUMERALS

1 . . . liquid crystal display device; 10, 100 . . . backlight; 10a, 10b, 10c, 10d, 10e, 10f, 10g, 10h, 10i, 10j, 10k, 10l, 10m, 10n . . . light emitting area; 11 . . . frame frequency converting portion; 11a . . . motion vector detecting portion; 11b . . . interpolation frame generating portion; 11c . . . area detecting portion; 12 . . . electrode driving portion; 13 . . . liquid crystal panel; 13T . . . translating area 14 . . . synchronization extracting portion; 15 . . . control CPU; 16 . . . light source driving portion; 101 . . . LED substrate; 102 . . . LED; 103 . . . harness; 104 . . . harness; 105 . . . chassis; and 106 . . . connector.

1-8. (canceled)

9. A liquid crystal display device comprising: a liquid crystal panel displaying an input video signal; a light source applying light to the liquid crystal panel, and a light source light emission control portion providing light emission control to each light emitting area acquired by dividing the light source into a plurality of areas, further comprising
an area detecting portion detecting any one of an area with a panning video, a telop area, and a scroll area as a translating area translating in a video indicated by the input video signal, and
a frame interpolating portion performing interpolation between frames of the input video signal to multiply a frame frequency before the interpolation by n (n is a natural number equal to or greater than two), wherein
the light source light emission control portion provides light emission control of the light emitting areas in synchronization with writing of a video signal to the liquid crystal panel, wherein the light emission control of the light emitting areas includes intermittent control in which the light source is intermittently repeatedly turned on and off, wherein the light source light emission control portion provides control of changing a current during a turn-on period and/or PWM control to a light emitting area to be provided with the intermittent control such that an average light emission luminance value of the light emitting area during the intermittent control is maintained at the same value as when the intermittent control is not provided, and wherein
for a light emitting area corresponding to the translating area detected by the area detecting portion, the intermittent control is provided only to the light emitting area or provided to the light emitting area such that a turn-off period becomes longer as compared to the other light emitting areas.

10. The liquid crystal display device as defined in claim 9, wherein the area detecting portion includes a motion vector detecting portion detecting a motion vector of the input video signal.

11. The liquid crystal display device as defined in claim 9, wherein the light emitting area corresponding to the translating area is a light emitting area entirely occupied by the translating area.

12. The liquid crystal display device as defined in claim 9, wherein the light emitting area corresponding to the translating area is a light emitting area having a predetermined rate of an area occupied by the translating area.

13. The liquid crystal display device as defined in claim 9, wherein the light emitting area corresponding to the translating area is a light emitting area including at least a portion of the translating area.

14. A television receiving apparatus comprising the liquid crystal display device as defined in claim 9.
